(19) United States
(12) Patent Application Publication
(10) Pub. No.: US 2004/0262351 A1
(43) Pub. Date: Dec. 30, 2004

(54) Piggyback carry-all

(76) Inventor: Dennis C. Hunt, Palm Coast, FL (US)

Correspondence Address: DENNIS C. HUNT, 100 PRINCE ERIC LN, PALM COAST, FL, 32164, US

(21) Appl. No.: 10/401,447

(22) Filed: Jun. 24, 2003

(51) Int. Cl. B60R 9/00; B60R 11/00

(52) U.S. Cl. 224/518

(57) ABSTRACT

The Piggyback Carry-All is a rack that allows you to mount one to two pods, a rowboat, canoe or other large object, two to four bicycles and a spare tire all at the same time to any size square bumper or to any size hitch mount of any vehicle. It also flips up and down for loading and unloading.

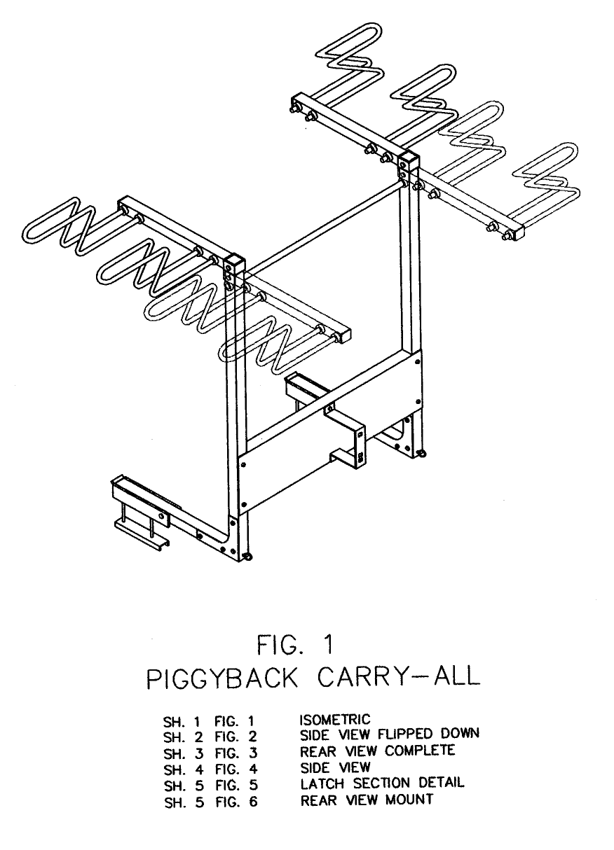

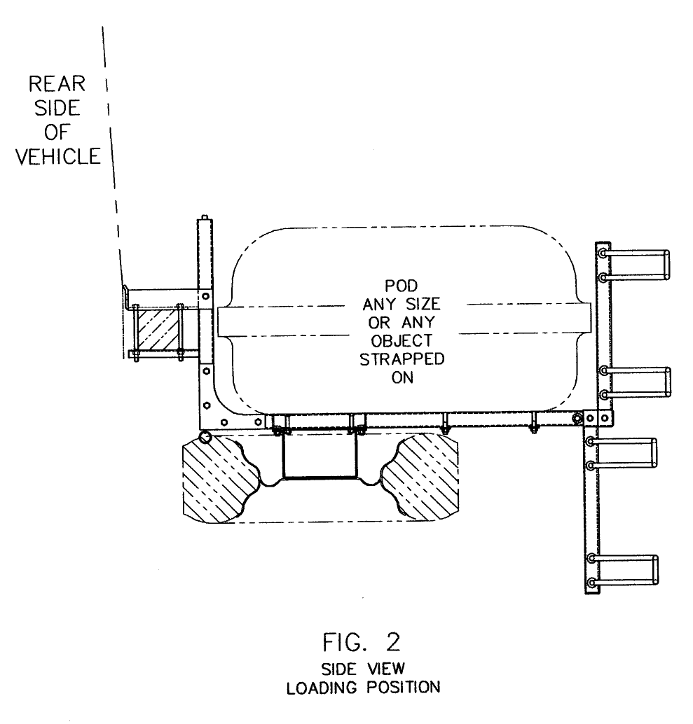

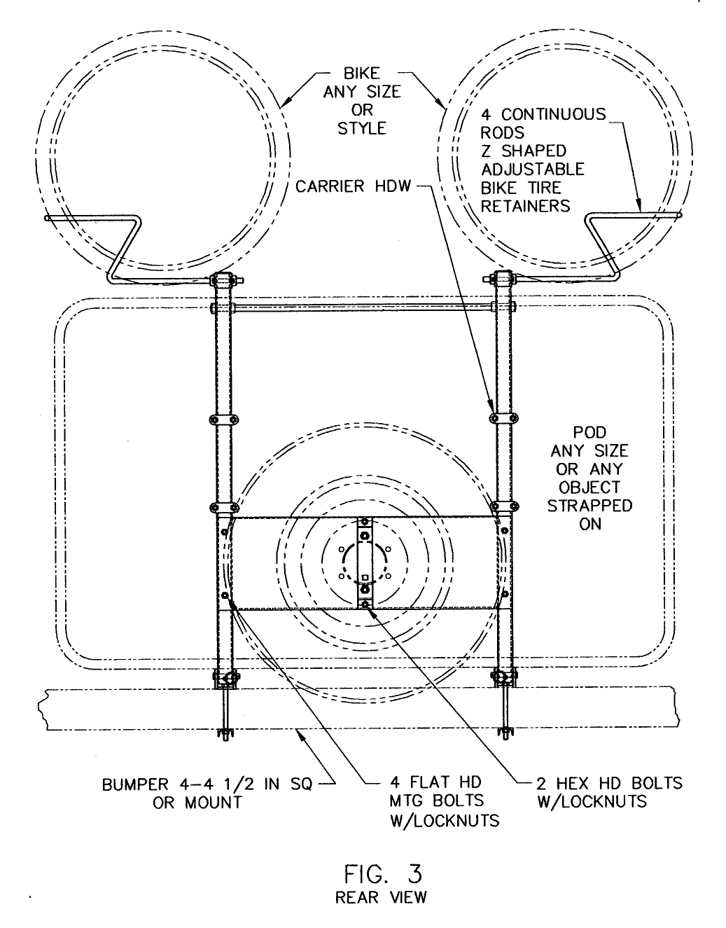

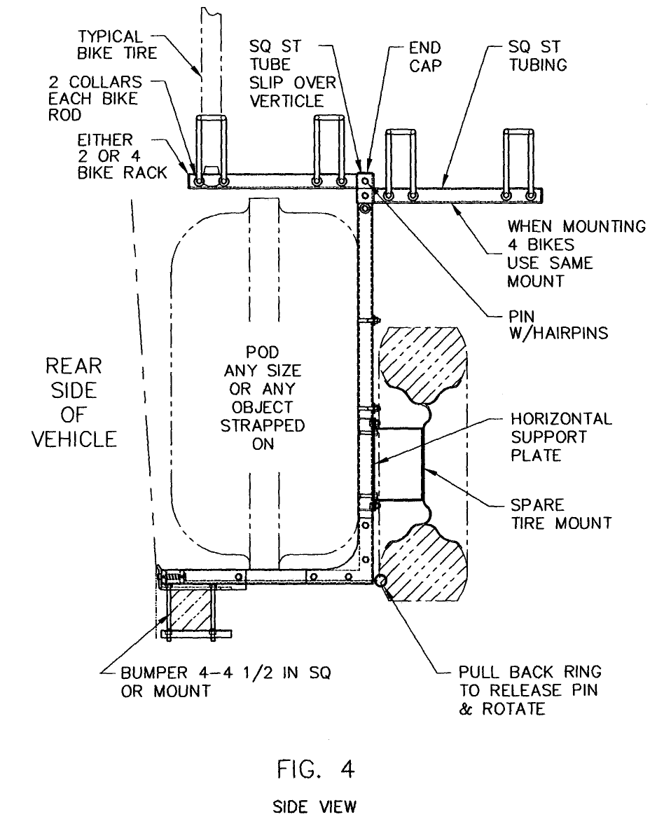

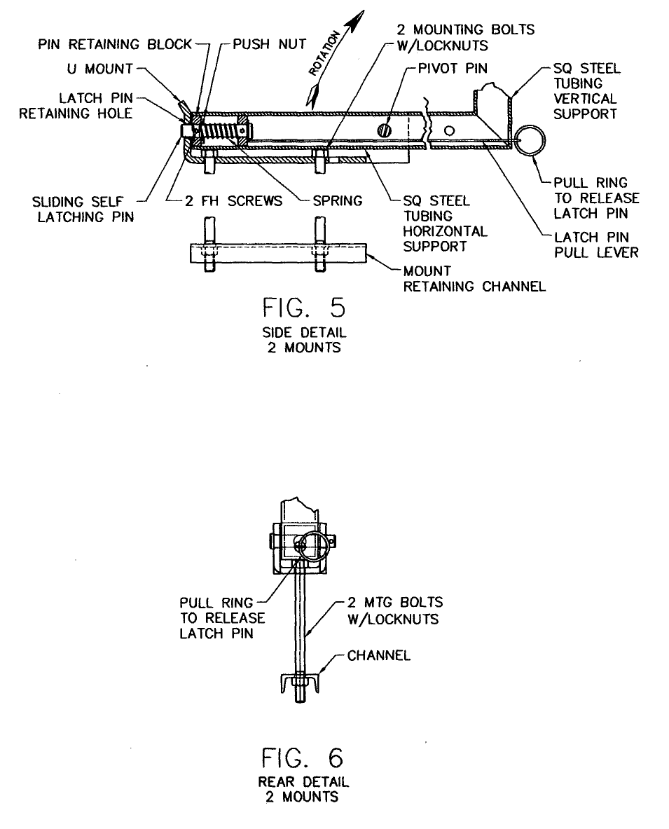

I am claiming the benefit of the filling date of Provisional Application 60/367,053

### SPECIFICATION

The Piggyback Carry-All is the only rack that allows you to mount one to two pods, a rowboats, canoe or other large object, two to four bicycles and a spare tire all at the same time at the rear of any vehicle.

The rack is constructed of two separate “L” shaped pieces of square tubing bolted together in the rear corner with spring loaded latching pins in the front ends that are retractable by pulling a ring at the rear. The “L” rotates by means of a pivot pin on the lower portion. These are tied together with a horizontal plate to attach the spare tire mount and a round handle at the top for lowering to load and raising to lock in place. In addition each “L” has slip on bicycle mounts also constructed of square tubing with adjustable “Z” shaped rods that hold the tires in place.

### SUMMARY

The Piggyback Carry-All is a rack that will mount to any square bumper on recreational vehicles or attached to a mount in the receiver hitch that enables vehicles to carry any additional gear on the back (examples: storage pods, bikes, spare tire, folding table & chairs, grill, rowboat or canoe).

No ladders required

Easier to load and unload

No wind resistance

No vibration or hopping while traveling

No scratching of the vehicle

Better fuel economy

Safer

1. What I claim as my invention is The Piggyback Carry-All which is the only carrier that allows you to mount one to two pods, a rowboat, canoe or other large object, two to four bicycles and a spare tire on a flip up and down rack all at the same time at the rear any vehicle.
